(19) United States
(12) Patent Application Publication
(10) Pub. No.: US 2015/0154161 A1
(43) Pub. Date: Jun. 4, 2015

(54) REQUESTING SERVICE

(71) Applicant: PORTA HOLDINGS LTD., Wickhams Quay (IO)

(72) Inventor: Jose Antonio Marquez, San Bruno, CA (US)

(21) Appl. No.: 14/271,229

(22) Filed: May 6, 2014

Related U.S. Application Data
(60) Provisional application No. 61/911,338, filed on Dec. 3, 2013.

(51) Int. Cl. G06F 17/22

(52) U.S. Cl. CPC G06F 17/2247

(57) ABSTRACT

Methods, systems, and apparatus, including computer programs encoded on computer storage media, for reducing browser network requests. One of the methods includes receiving a markup language document. Resource requests in the markup language document are identified and a combined request is generated, the combined request comprising respective resource locations for the resource requests. The combined request is provided to a requesting service. A combined response is received from the requesting service, the combined response comprising representations of one or more respective resources for the plurality of resource requests. The resource requests are resolved using the representations of the one or more resources of the combined response, and a rendered document is generated from the markup language document and the resolved resource requests of the markup language document.

### CROSS-REFERENCE TO RELATED APPLICATIONS

This application claims the benefit under 35 U.S.C. §119(e) of the filing date of U.S. Provisional Patent Application No. 61/911,338, filed on Dec. 3, 2013, entitled “Requesting Service,” the entirety of which is herein incorporated by reference.

### BACKGROUND

This specification relates to network communication.

Markup language documents can include network requests for resources, e.g., network locations of images to be included in rendered version of the markup language document. A client application, e.g., a web browser, can make requests for the resource at their respective network locations, e.g., URLs. The client application can then receive the resource and render the markup language document with the received resources.

### SUMMARY

This specification describes how a system can use a requesting service to obtain resources for rendering a markup language document on a client device. A client application, e.g., a web browser, generates a combined request for multiple resources in the markup language document and provides the combined request to a requesting service backend. The requesting service backend obtains the resources and provides the resources in a combined response. The client application then loads the resources into memory from the combined response and renders the markup language document from the resources loaded into memory.

In general, one innovative aspect of the subject matter described in this specification can be embodied in methods that include the actions of receiving a markup language document; identifying a plurality of resource requests in the markup language document, wherein each resource request specifies a resource at a respective resource location; generating a combined request comprising respective resource locations for the plurality of resource requests; providing the combined request to a requesting service; receiving, from the requesting service, a combined response comprising representations of one or more respective resources for the plurality of resource requests; resolving the resource requests using the representations of the one or more resources of the combined response; and generating a rendered document from the markup language document and the resolved resource requests of the markup language document. Other embodiments of this aspect include corresponding computer systems, apparatus, and computer programs recorded on one or more computer storage devices, each configured to perform the actions of the methods. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

The foregoing and other embodiments can each optionally include one or more of the following features, alone or in combination. Resolving the resource requests using the representations of the one or more resources of the combined response comprises allocating a respective memory object for each of the representations of the resources in the combined response; and loading the representations of the resources into the respecting allocated memory objects, wherein generating the rendered document from the markup language document and the resolved resource requests and the markup language document comprises generating the rendered document using in memory pointers to the respective allocated memory objects. The actions include generating a modified markup language document including replacing references in the markup language to the resource locations with in memory pointers to the respective allocated memory objects, wherein generating the rendered document from the markup language document and the resolved resource requests and the markup language document comprises generating a rendered document from the modified markup language document. Identifying a plurality of resource requests in the markup language document comprises loading and interpreting a style sheet within the document; and parsing the interpreted style sheet for embedded requests. The combined response includes an external cascading style sheet, and the actions include determining that the external cascading style sheet includes a second resource request; generating a second combined request including the second resource request; receiving a second combined response comprising a representation of the second resource; and resolving the second resource request using the representation of the second resource in the second combined response. The actions include determining that the external cascading style sheet includes a second resource request; generating a second combined request including the second resource request; receiving a second combined response comprising a representation of the second resource; and resolving the second resource request using the representation of the second resource in the second combined response. The requesting service obtains the respective resources from the plurality of resource locations and generates the combined response. Generating a combined request comprising respective resource locations for the plurality of resource requests comprises determining that a particular resource is a cached resource; including a token of the cached resource in the combined request; determining that the combined response indicates that the cached resource is valid; and resolving the resource request using the cached resource. The actions include respective resource locations for the plurality of resource requests comprises: Generating a combined request comprising respective resource locations for the plurality of resource requests comprises determining that a particular resource is a cached resource; including a token of the cached resource in the combined request; determining that the combined response indicates that the cached resource is not valid; and resolving the resource request using a representation of the particular resource in the combined response.

In general, another innovative aspect of the subject matter described in this specification can be embodied in methods that include the actions of receiving a combined request for resources, the combined request including resource requests for a plurality of embedded requests in a markup language document, wherein each resource request specifies a resource at a respective resource location; obtaining each respective resource for the plurality of embedded requests; generating a combined response comprising representations of one or more of the obtained resources; and providing the combined response in response to receiving the combined request. Other embodiments of this aspect include corresponding computer systems, apparatus, and computer programs recorded on one or more computer storage devices, each configured to perform the actions of the methods.

Particular embodiments of the subject matter described in this specification can be implemented so as to realize one or more of the following advantages. Using a requesting service to render documents reduces latency required for a client application to resolve requests for multiple resources in a markup language document. The client application can also fulfill multiple requests for resources using a single thread, which improves responsiveness of the application and reduces processing load on a client device.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of an example system.

FIG. 2 is a flow chart of an example process for rendering a markup language document.

FIG. 3 is a flow chart of an example process for generating a combined response

FIG. 4 is a flow chart of an example process for rendering a markup language document that includes cascading style sheets.

FIG. 5 is a flow chart of an example process for rendering a markup language document that includes nested embedded requests.

FIG. 6 is a flow chart of an example process for caching resources for a requesting service.

FIG. 7 is a flow chart of an example process for caching resources for a requesting service.

Like reference numbers and designations in the various drawings indicate like elements.

### DETAILED DESCRIPTION

Latency and responsiveness of rendering markup language documents that include embedded requests can be improved by using a requesting service. In general, a web browser can combine individual embedded network requests in a document into a combined request and can provide the combined request to a requesting service. The requesting service then handles retrieving the resources from their respective resource locations. The web browser then receives a combined response that includes representations of the requested resources and renders the markup language document using the representations of the requested resources in the combined response.

In the systems described below, the functionality of the requesting service will be described as being implemented by a frontend module and a backend module. The operations of the frontend or backend module may be referred to simply as operations performed by the requesting service when the meaning is clear from context.

Typically, the frontend module of the requesting service is installed on a user device that is loading and rendering a markup language document, and the backend module of the requesting service is installed on a separate computing device that is remote from the user device. However, all functionality of the requesting service can also be implemented on a single device or more than two devices as well.

Although described as separately installed modules, the functionality of the frontend and backend modules of the requesting service may alternatively be integrated by components of other systems. For example, the functionality of the backend module may be integrated by content serving systems. In other words, the content serving systems may serve data in a format that is ready to be consumed by the requesting service frontend. Similarly, the functionality of the frontend module may be integrated a web browser. In other words, the web browser can then natively render documents using data representations received from systems that implement the functionality of the requesting service backend.

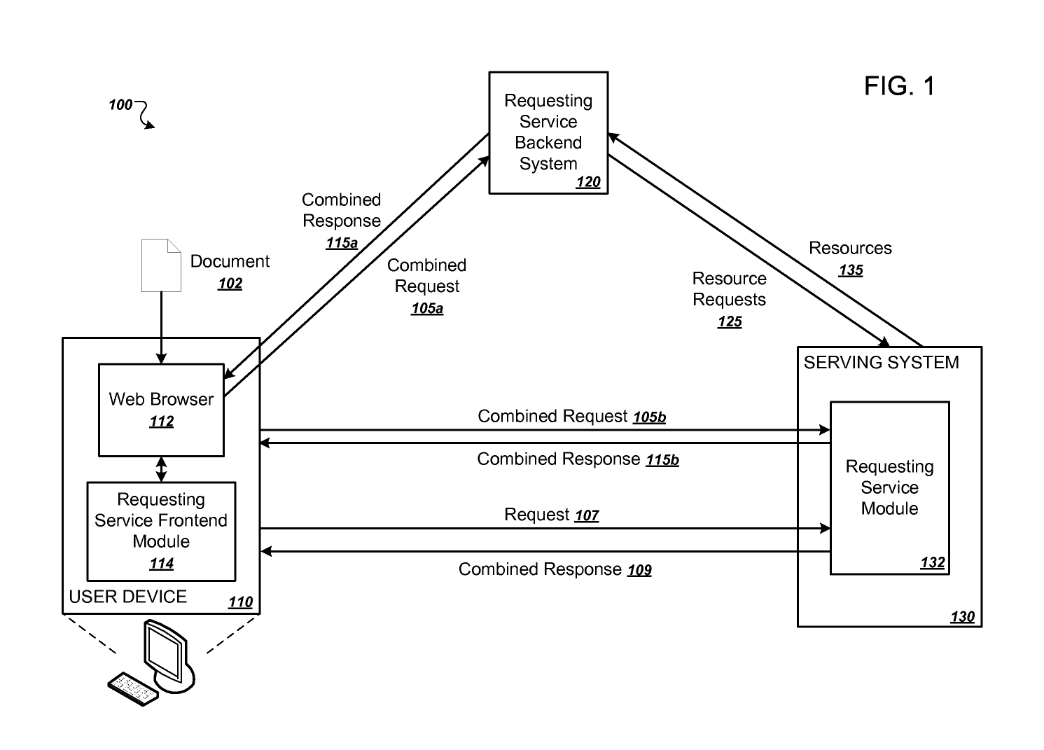

FIG. 1 is a diagram of an example system 100. The system includes a user device 110 in communication with a serving system 130 as well as requesting service backend system 120. The components shown in FIG. 1 can communicate with one another over any appropriate communications network, e.g., an intranet or the Internet. Alternatively, two or more of the components in FIG. 1 can be installed on a single computing device.

The user device 110 can be any appropriate type of computing device, e.g., a mobile phone, tablet computer, notebook computer, music player, e-book reader, laptop or desktop computer, that includes one or more processors and computer readable media. The user device 110 includes computer readable media that stores installed software applications, including a web browser 112 and a requesting service frontend module 114.

In general, the user device 110 receives a markup language document 102, e.g. over the Internet, and the user device 110 uses the web browser 112 to parse and render the document 102 on a display device of the user device 110. The web browser 112 can be any appropriately programmed component that renders markup language documents.

The system 100 includes a serving system 130. The serving system 130 is a system of one or more computers installed in one or more locations that receives requests for resources and serves resources in response to the requests. A resource is any data that can be provided by the serving system 130 over a network. Each resource is typically associated with a resource locator, e.g., a uniform resource locator (URL). Resources may include markup language documents, image files, video files, audio files, scripts, and cascading style sheets (CSS), to name just a few examples. For example, the user device 110 can receive the markup language document 102 from the serving system 130.

In Table 1, below, is a segment of markup language code for an example document.

TABLE 1

```
<!DOCTYPE html>
<html>
  <body>
    <h1>Hello World!</h1>
    <img src=″img/IMAGE1.png″ />
    <img src=″img/IMAGE2.png″ />
    <img src=″img/IMAGE3.png″ />
  </body>
</html>
```

The example document in Table 1 includes the text “Hello World!” and resource requests for three images at respective resource locations. In this example, the resource locators specify that the images are located in a subdirectory “img” from a location of the document on a particular serving system. Requests for resources within the markup language itself will be referred to as embedded requests.

Upon receiving the example document, the web browser 112 of the user device 110 will parse the markup language code in order to render the document. To do so, the web browser 112 must make each of the embedded requests for the three images using their respective resource locators. In this example, the web browser 112 may make three separate requests to a serving system in order to retrieve the images needed to render the document on the user device 110.

To improve the latency and responsiveness of loading and rendering the document 102, the web browser 112 can make use of a requesting service. The requesting service frontend module 114 is a functional module, e.g., an engine, a package, or a library, that the web browser 112 can use to render markup language documents.

The requesting service frontend module 114 modifies the typical behavior of the web browser 112. Instead of making a separate request for each embedded request in the markup language document, the frontend module 114 will cause the browser to generate and provide a combined request to a requesting service backend. The requesting service backend will then retrieve the resources of the embedded requests and generate a combined response, which the web browser will use to render the markup language document. In general, the requesting service can attempt to process all embedded requests using a single combined request and a single combined response, although multiple combined requests and combined responses may be required in some situations.

The requesting service backend can be implemented in a requesting service backend system 120 as a system of one or more computers installed in one or more locations. The requesting service backend can also be implemented as a functional module 132 of a serving system 130 such that the serving system itself performs the operations of the requesting service backend.

For example, the web browser 112 can combine the embedded requests into a combined request 105a, which can be provided over a network to a requesting service backend system 120. The requesting service backend system 120 will parse the combined request 105a into individual resource requests and provide the individual respective resource requests 125 to the appropriate serving system 130. In response, the serving system 130 will provide the resources 135 back to the requesting service backend system 120. Although only one serving system 130 is shown, the requesting service backend system can make resource requests 125 to multiple different serving systems to obtain the resources 135.

The requesting service backend system 120 will then generate and provide a combined response 115a that includes all the data needed for the web browser 112 to render the document 102.

As an alternative to having a separate a requesting service backend system 120, the serving system 130 can make use of a requesting service module 132 when serving resources. Rather than serving individual resources in response to individual requests, the web browser 112 can provide a combined request 105b to the serving system 130. The serving system can then use the requesting service module 132 to generate a combined response 115b that includes representations of all the resources needed for the web browser 112 to render the document 102. The serving system 130 can thus obtain resources both locally and from remote resource locations when generating the combined response 115b.

Some of the functionality of the requesting service frontend module 114 may also be performed by the serving system 130. For example, for a markup language document being served, e.g., document 102, the serving system can parse the document 102 using multiple different web browsers to locally generate representations of how each browser would render the document. The serving system 130 can then pregenerate respective combined responses for rendering the document 102 in each of the multiple web browsers. In other words, the serving system 130 can generate combined responses offline, before receiving a request 107 for a document.

Thus, when requesting the document 102, the user device 110 need not use the requesting service frontend module 114 to generate a combined request. Instead, the user device 110 can provide a regular request 107 for the document 102. In response, the serving system 130 can determine which web browser provided the request from the user device 110 and serve the appropriate pregenerated combined response 109 that corresponds to the web browser.

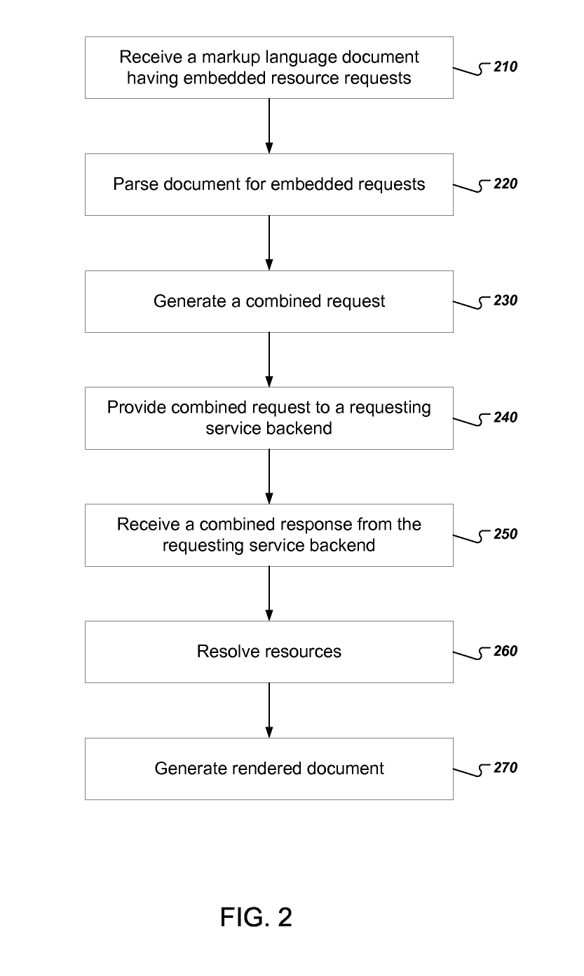

FIG. 2 is a flow chart of an example process for rendering a markup language document. In general, a web browser can use a requesting service to combine embedded requests for resources in a markup language document. The process can be implemented by one or more computer programs installed on one or more computers. The process will be described as being performed by an appropriately programmed system of one or more computers, e.g., the user device 110 of FIG. 1.

The system receives a markup language document having embedded resource requests (210). Rather than loading the document directly, the system can make use of a requesting service.

The requesting service can be invoked by an application programming interface (API) call to a script library, e.g., a provided Javascript library, or can be invoked as functionality implemented natively by a web browser. For example, a web browser may automatically load documents using a particular requesting service.

The markup language document itself may include instructions indicating that the document is to be loaded using a requesting service. In Table 2 is example code of a markup language document that instructs the system to load the document using a requesting service.

TABLE 2

```
<script type=″text/requester-serialization″>
  {
    ″self″: true
    ″service″: ″http://example.com/service/api/for/uris″
  }
</script>
```

The example code includes a script serialization element that has a type “text” and a subtype “requester-serialization.” The type and subtype instruct the web browser to handle the document by invoking the requesting service frontend library. The script element includes two properties. The “self” property being set to “true” specifies that the current markup language document is to be loaded using the requesting service.

The “service” property specifies a location of a requesting service backend responsible for retrieving and combining resources of the embedded requests into a combined response. For example, a serving system that provides the document can also host the requesting service. Thus, a serving system can specify, in documents the system serves, the location of the requesting service it provides or the location of a requesting service provided by a third party.

If the browser natively supports using a requesting service, the document need not include a script element in order for the browser to make use of a requesting service. In addition, these and other parameters mentioned below can be configured, e.g., by a user, using settings of the browser rather than the parameters being specified in the script element itself.

The system can load a “preload document” that will invoke the requesting service. In Table 3 is code of an example preload document.

TABLE 3

```
<script type=″text/requestr-serialization″>
  {
    ″owner″: ″pages/index.html″,
    ″service″: ″http://example.com/service/api/for/uris″
  }
</script>
```

The example preload document includes a single script serialization element that includes two properties. The “owner” property specifies the name of the markup language document that is to be loaded by the browser. The “service” property specifies a location of a requesting service backend that will retrieve and combine multiple resources into a combined response.

The script element that invokes the requesting service can also be used to specify a number of other configuration parameters that control how the requesting service will handle retrieving embedded resources in the document.

For example, the script element can include a “maxFileSize” property that specifies a maximum size of resources to be included in a combined response. Other embedded resource requests can be handled by the browser using conventional resource requests.

The script element can also include an “allow” property that specifies a filter for allowed domains or URIs to be retrieved using the requesting service. Other resource locations will be handled using conventional resource requests. The script element can also include an “exclude” property that specifies a filter for resource locations to be excluded.

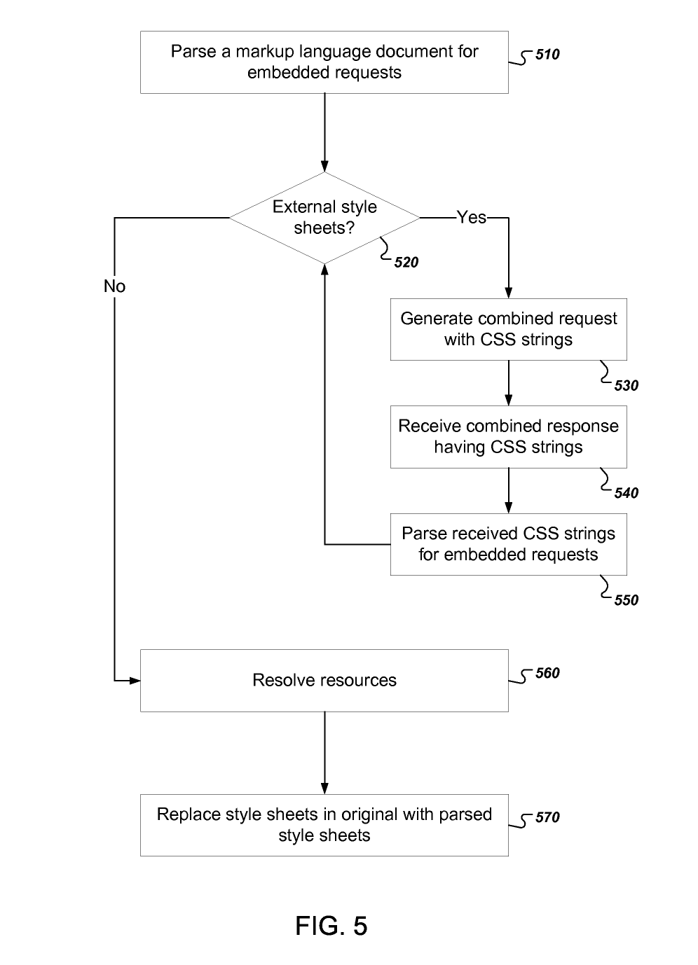

The system parses the document for embedded requests (220). In general, the system parses the document to generate a document object model (DOM). The DOM is a tree structure that represents the layout of objects in markup language documents. The system traverses the DOM and generates an initial set of embedded requests. Some document objects may require subsequent or special parsing steps, which will be described in more detail below with reference to FIG. 5. Notably, the system does not request or retrieve the actual resources specified by the embedded requests.

The system generates a combined request (230). The combined request includes resource locations for the embedded requests in the document. The combined request can be represented by any appropriate data structure, e.g., as a JavaScript Object Notation (JSON) string. Table 4 includes an example combined request in JSON format.

TABLE 4

```
{
  ″MaxSize″: 100000,
  ″Urls″: [{
    ″Url″: ″http://example.com/file.txt″,
    ″Token″: null,
    ″Type″: ″STRING″
  }, {
    ″Url″: ″http://example.com/img/IMAGE2.png ″,
    ″Token″: null
  }, {
    ″Url″: ″http://example.com/img/IMAGE3.png ″,
    ″Token″: null
  } ]
}
```

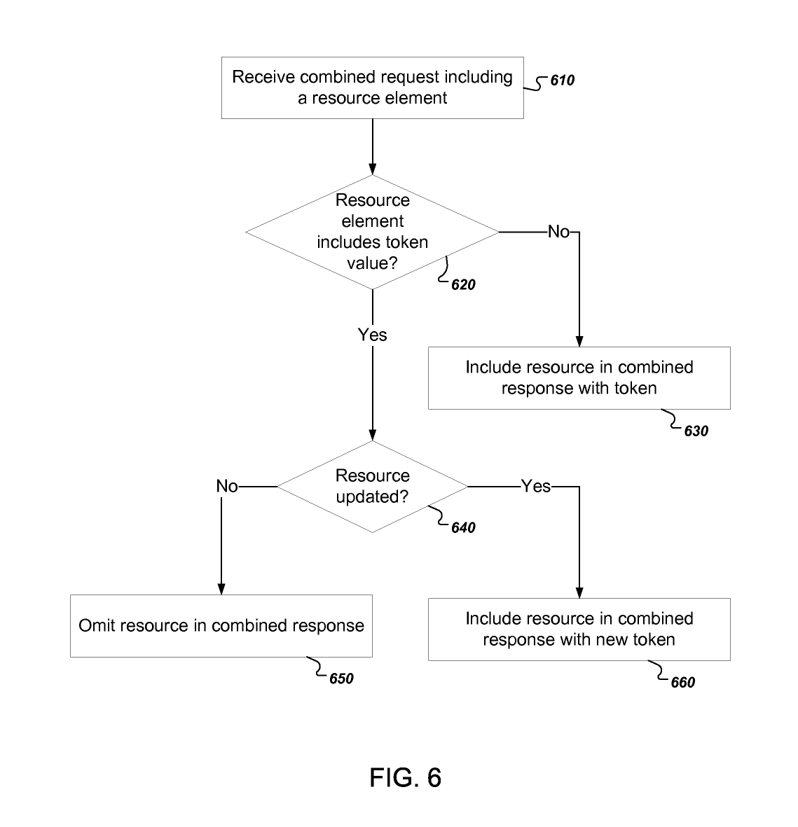

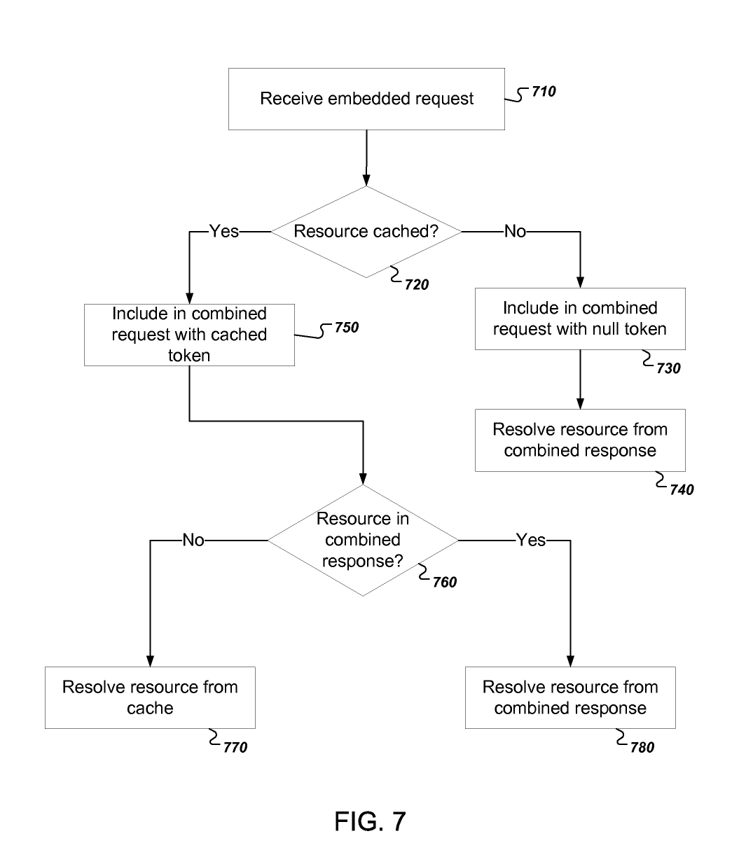

The combined request optionally includes a “MaxSize” property that specifies a maximum size of resources to be retrieved by the requesting service backend. The “Urls” property includes information for each of the embedded requests and can be represented as an array of resource request elements. Each element includes the resource location, “Url,” of the resource, an optional “Token” string, and optional “Type.” The “Token” can be used for caching, which will be described in more detail below with reference to FIGS. 6-7.

The “Type” property specifies in what format the resource should be retrieved. The default type can be a “DATA URI” type, indicating that the resource should be returned as a data uniform resource identifier (URI). A data URI is a representation of a resource in a particular character encoding. In other words, resources, even images or videos, can be retrieved as a particular kind of text. The “Type” property can alternatively specify that some resources should be retrieved as strings. In particular, resources that need to be parsed by the browser, e.g., CSS's, are typically retrieved as strings.

The system provides the combined request to a requesting service backend (240). As described above, the requesting service backend can be implemented by a separate computer system or by a serving system itself. The location of the requesting service backend can be specified when the requesting service is invoked, as described above.

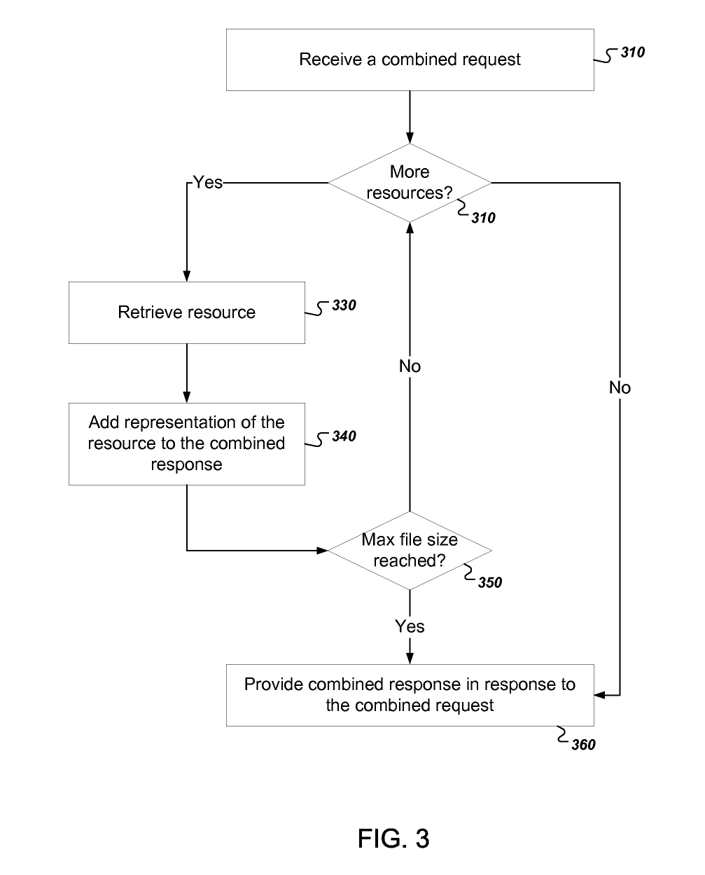

The requesting service backend receives the combined request and retrieves the resources at their respective resource locations as specified in the combined request. The requesting service backend will be described in more detail below with reference to FIG. 3.

The system receives a combined response from the requesting service backend (250). In general, the combined response will include a representation of all data needed to render the markup language document. For example, resources can be represented as data URIs in the combined response, and strings can be represented as text in the combined response.

Table 5 includes an example combined response in JSON format.

```
TABLE 5
{
  ″Resources″ : [ {
    ″Data″ : ″123 Main St.″,
    ″ContentType″ : ″text″,
    ″Url″ : ″http://example.com/file.txt ″,
    ″Token″ : ″3OfYo/annI+C1uh67p6tiQg5WKk=″,
    ″Type″ : ″STRING″
  }, {
    ″Data″ : ″data:image/png;base64,iVBORw0KGgoAAAUhEUgAAA...″,
    ″ContentType″ : ″image/png″,
    ″Url″ : ″http://example.com/IMAGE2.png″,
    ″Token″ : ″i7KtDrV73sge+kZRyKAhKbqukqY=″,
    ″Type″ : ″DATA_URI″
  }, {
    ″Data″ : ″data:image/png;base64,AANSUhEUgAAA...″,
    ″ContentType″ : ″image/png″,
    ″Url″ : ″http://example.com/IMAGE3.png″,
    ″Token″ : ″s1Aunwxs3fTeXFFVd5tcMlJ9FM0=″,
    ″Type″ : ″DATA_URI″
  } ]
}
```

The example combined response shown in Table 5 includes an array of resource elements, with each resource element including a representation of the resource needed to render the document.

Each resource element includes a “Data” property that includes the data needed to render the resource. The portions represented by underlining in Table 5 indicate data URI strings for example images, which will typically be significantly longer than the strings shown in Table 5.

Each resource element also includes a “ContentType” property indicating the type of the resource, a “Url” property indicating the original resource location of the resource, a “Token” property used for caching, and a “Type” property of the requested resource.

In some implementations, the requesting service implements local caching of the resource data representations. Thus, the system can store in a caching database each resource element of the combined response. Caching will be described in more detail below with reference to FIGS. 6-7.

The system resolves the resources (260). In general, resolving the resources includes re-parsing the original document and using the resources from the combined response to render the document.

For some content types, e.g., as specified by the “ContentType” property in the combined response, the system performs a separate parsing step. For example, CSS resources typically require a separate parsing step, which will be described in more detail below with reference to FIG. 5.

For all other content types of resources in the combined response, the system allocates one or more portions of memory, with each memory portion having a respective pointer. In some implementations, the system generates a respective binary large object (Blob) in memory. The system then replaces the embedded resource requests in the original document with pointers to the corresponding in-memory Blobs.

Table 6 represents markup language code of a modified version of the example document from Table 1. The modified version has the resource locators replaced with pointers to in-memory Blobs.

```
TABLE 6
<body>
  <h1>Hello World!</h1>
  <img src=″blob:http%3A//requestr%3A8488/fa0cd56b-a3fc-4e6e″ />
  <img src=″blob:http%3A//requestr%3A8488/5f5c418b-9d83-4e6″ />
  <img src=″blob:http%3A//requestr%3A8488/3705b1b3-d7e1-4ec″ />
</body>
```

The system can generate the modified version of the markup language document so that the original document is unaltered. Thus, the code of the modified markup language document shown in Table 6 can be generated and loaded by the browser only at runtime.

The system generates a rendered document (270). The system uses the modified markup language document with the replaced pointers to in-memory Blobs to render the document for display on a display device of a user device.

FIG. 3 is a flow chart of an example process for generating a combined response. In general, a requesting service backend receives a combined request that includes multiple resource requests. The requesting service backend retrieves the resources from their respective locations and generates a combined response, which is provided in response to the combined request. The process can be implemented by one or more computer programs installed on one or more computers. The process will be described as being performed by an appropriately programmed system of one or more computers, e.g., the requesting service backend system 120 or the serving system 130 of FIG. 1.

The system receives a combined request (310). The combined request will generally specify a number of resource locators for respective resources. An example combined request is shown above in Table 4. As shown in Table 4, the combined request may specify a maximum file size for the combined response.

The combined request can be received remotely from a user device, e.g., by a requesting service backend system. Alternatively, a serving system can generate the combined request locally. For a particular document being served, the serving system can parse the document using each of multiple web browsers to generate a representation of how each of the web browsers would render the document. For example, the serving system could provide the document to each of multiple virtual machines, each virtual machine running a different web browser, in order to obtain representations of how each web browser would render the document.

The system determines if more resources remain to be retrieved (320). The system can determine if all embedded resource requests in the document have been fulfilled. If more resources remain to be retrieved, the system retrieves the next resource from its resource location as specified in the combined request (branch to 330). For example, the system can retrieve an image or text from a particular resource location.

The system adds a representation of the resource to the combined response (340). As described above, the system can generate a text representation of the resource using a data URI. The system can then add an element to the combined response that includes the text of the data URI, for example, as shown in the example of Table 5.

If the requesting service supports caching, the system can generate a unique token for each resource and add the token property to the resource element in the combined response. Caching will be described in more detail below with reference to FIGS. 6-7.

The system determines if a maximum file size of the combined response has been reached (350). If the maximum file size has been reached, the system provides the combined response in response to the combined request (branch to 360).

If the maximum file size has not been reached or has not been specified, the system determines whether there are more resources to retrieve from the combined request (branch to 310). If not, the system provides the combined response in response to the combined request (branch to 360).

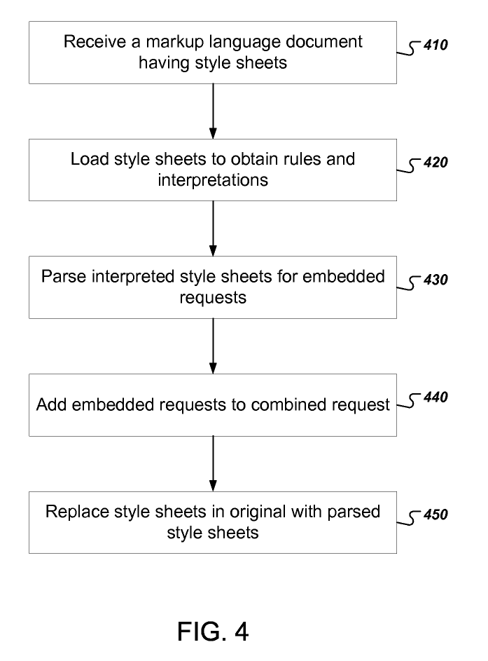

FIG. 4 is a flow chart of an example process for rendering a markup language document that includes cascading style sheets. A cascading style sheet is a language used to describe the formatting of a markup language document. Not all browsers support all CSS rules. Thus, a requesting service can let a browser handle CSS rules before attempting to render the document. The process can be implemented by one or more computer programs installed on one or more computers. The process will be described as being performed by an appropriately programmed system of one or more computers, e.g., the user device 110 of FIG. 1.

The system receives a markup language document having a cascading style sheet (410). In Table 7, below, is a segment of markup language for an example document that includes a style sheet specification.

TABLE 7

```
<!DOCTYPE html>
<html data-test=″testing″>
  <head>
    <style type=″text/css″>
      * {
        font-family: cursive;
        font-weight: 100;
        color: #FFF;
      }
      body {
        background-image: url(background.jpg);
        background-position: center center;
        background-repeat: no-repeat;
      }
    </style>
  </head>
  <body>
    <h1>Hello World !</h1>
    <a href=″../iframe.html″ target=″parent″>Test Link</a>
    <img src=″img/IMAGE1.png″ />
    <img src=″img/IMAGE2.png″ />
    <img src=″img/IMAGE3.png″ />
  </body>
</html>
```

The system loads the style sheet to obtain rules and interpretations (420). The requesting service will rely on the web browser's CSS interpretation to obtain embedded requests in the style sheet.

The system parses the interpreted style sheet for embedded requests (430). In the example shown in Table, the style sheet includes an embedded request for “background.jpg,” represented by the underlined portion of the table. After obtaining embedded requests in the interpreted style sheets, the system can treat the embedded requests similarly to other embedded requests in the document.

Thus, the system adds the embedded requests to the combined request (440). For example, the system can generate a request element for “background.jpg” to be included in the combined request show in the example of Table 4.

The system will then receive the combined response from the requesting service backend and resolve the resources as described above with reference to FIG. 2.

To handle the style sheets, the system replaces the style sheet in the original with the parsed style sheet (450). In other words, the system can replace the URL for “background.jpg” in the style sheet with a Blob URL for the retrieved representation “background.jpg.”

FIG. 5 is a flow chart of an example process for rendering a markup language document that includes nested embedded requests. Some resources that are retrieved by the requesting service may themselves include embedded requests, which may be referred to as nested embedded requests. For example, a markup language document may include an embedded request to an external style sheet, which itself includes embedded requests to other resources. A requesting service can handle nested embedded requests using multiple combined requests and responses for each level of nesting. The example process will be described in terms of external style sheets, although the process can be equivalently applied to any type of resource that includes nested embedded requests. The process can be implemented by one or more computer programs installed on one or more computers. The process will be described as being performed by an appropriately programmed system of one or more computers, e.g., the user device 110 of FIG. 1.

The system parses a markup language document for embedded requests (510). The system can parse a markup language document for embedded requests as described above with reference to FIG. 2 or FIG. 4. If the markup language document includes cascading style sheets, the system may first load the style sheet to obtain the web browser's specific rules and interpretations for the style sheet.

The system determines whether the markup language document includes an embedded request to an external style sheet (520). In Table 8 is example code of a markup language document that includes an embedded request to an external style sheet.

TABLE 8

```
<!DOCTYPE html>
<html data-test=″testing″>
  <head>
    <link href=″css/style.css″ rel=″stylesheet″ />
  </head>
  <body>
    <h1>Hello World!</h1>
    <a href=″../iframe.html″ target=″_parent″>Test Link</a>
    <img src=″img/IMAGE1.png″ />
    <img src=″img/IMAGE2.png″ />
    <img src=″img/IMAGE3.png″ />
  </body>
</html>
```

In Table 8, the “link” element includes an embedded request to an external style sheet at resource location “css/style.css”. Thus, the system can retrieve the external style sheet and parse it for nested embedded requests in a separate parsing step.

If the document includes an embedded request to an external style sheet, the system generates a combined request having CSS strings (branch to 530). In other words, the system specifies that the CSS resource should be retrieved with “ContentType” of “STRING,” so that it can be immediately parsed by the browser, rather than being retrieved as a data URI.

The system receives a combined response having CSS strings (540). The system can receive the combined response from the requesting service backend as described above with reference to FIG. 2.

The system parses the received CSS strings for embedded requests (550). The system can then determine whether any of the CSS strings include an embedded request to an external style sheet (520). If so, the system can generate another combined request having CSS strings and parse the combined response for embedded requests (branch to 530).

If not, the system can proceed to resolve the resources in the combined responses (560). The system can then replace the style sheets in the original document with the parsed style sheets (570).

FIG. 6 is a flow chart of an example process for caching resources for a requesting service. Because the requesting service handles embedded requests differently than a browser ordinarily would, the combined requests and responses are typically not handled by a browser's cache. Thus, the requesting service can implement its own caching process. In general, the requesting service backend can generate a unique token for each retrieved resource. If, on a subsequent request, the resource has been updated, the requesting service backend can include a new token indicating that the new version of the resource should be used rather than any cached versions. If the resource has not been updated, the requesting service backend can omit the resource entirely from the combined response. The process can be implemented by one or more computer programs installed on one or more computers. The process will be described as being performed by an appropriately programmed system of one or more computers, e.g., the requesting service backend system 120 of FIG. 1.

The system receives a combined request including a resource element (610). The combined request will include elements for one or more resource requests. Each element can include a “Token” property that the system can use to determine whether a cached version of the resource at the user device is valid.

The system determines whether the resource element includes a token value (620). If the resource element includes no value for the “Token” property or a null value for the “Token” property, the system can determine that no cached version exists. The system can thus include the representation of the resource, e.g., a data URI, when generating the combined response (branch to 630). The system can also include a new token for the resource in the combined response.

If the resource element does include a token value, the system determines whether the resource has been updated (branch to 640). The system can for example generate the token values using a last updated date of the resource. Thus, when the resource is updated, the token value will generally change as well.

If the resource has not been updated, the system can omit the resource in the combined response (branch to 650). In other words, the system need not include the representation of the resource in the combined response, which further improves latency and reduces the size of the combined response.

Alternatively, the system can include information about the resource in the combined response, e.g., the current token value, but without including the entire data representation of the resource in the combined response.

If the resource has been updated, the system can include the resource in the combined response along with a new token (branch to 660).

FIG. 7 is a flow chart of an example process for caching resources for a requesting service. In general, a requesting service frontend can store resolved resources in a caching database along with tokens generated by the requesting service backend. In subsequent requests to load the document, the requesting service frontend can include the token in the combined request. If the requested resource is absent from the combined response or if the combined response indicates that the token value has not changed, the requesting service frontend can resolve the resource from the cached database rather than from data in the combined response. The process can be implemented by one or more computer programs installed on one or more computers. The process will be described as being performed by an appropriately programmed system of one or more computers, e.g., the user device 110 of FIG. 1.

The system receives an embedded request (710). The embedded request can be included in a markup language document being parsed.

The system determines whether the resource has been cached (720). The system can check to see whether the resource has been stored in a caching database. In some implementations, the system stores information about resolved resources in the database. Each entry in the database can be keyed by resource locator of the resource and include other information, including the last token value generated by the requesting service backend and last date retrieved, to name just a few examples.

If the resource is not cached, the system can include the embedded request in the combined request along with a null token value (730). In some implementations, including a null token value can prevent the requesting service backend from performing a check on whether the resource has been updated.

After receiving the combined response, the system resolves the resource from the combined response (740). The system can then store the resolved resource in the caching database.

If the resource is cached, the system can include the token stored with the resource in the combined request (branch to 750). The requesting service backend can then use the token to determine whether the resource has been updated.

In some implementations, even if the resource is cached, the system can request an updated resource by specifying a null token value for a particular resource in the combined request. For example, the system can request updated resource whenever any resource in the cache is older than a particular amount, e.g., one day, one week, or one month.

After receiving the combined response, the system determines whether the resource was included in the combined response (760). Alternatively, the system can determine whether information in the combined response indicates that the cached version of the resource is still valid. For example, the combined response can include a token of the resource but omit an entire data representation of the resource.

If the resource is included in the combined response, the system can resolve the resource from the caching database (branch to 770).

If the resource was included in the combined response, the system can resolve the resource from the combined response (780). The system can also store the resolved resource in the caching database.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them. The computer storage medium is not, however, a propagated signal.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
receiving a markup language document;
identifying a plurality of resource requests in the markup language document, wherein each resource request specifies a resource at a respective resource location;
generating a combined request comprising respective resource locations for the plurality of resource requests;
providing the combined request to a requesting service;
receiving, from the requesting service, a combined response comprising representations of one or more respective resources for the plurality of resource requests;
resolving the resource requests using the representations of the one or more resources of the combined response; and
generating a rendered document from the markup language document and the resolved resource requests of the markup language document.

2. The method of claim 1, wherein resolving the resource requests using the representations of the one or more resources of the combined response comprises:
allocating a respective memory object for each of the representations of the resources in the combined response; and
loading the representations of the resources into the respecting allocated memory objects, wherein generating the rendered document from the markup language document and the resolved resource requests and the markup language document comprises generating the rendered document using in-memory pointers to the respective allocated memory objects.

3. The method of claim 2, further comprising:
generating a modified markup language document including replacing references in the markup language to the resource locations with in-memory pointers to the respective allocated memory objects,
wherein generating the rendered document from the markup language document and the resolved resource requests and the markup language document comprises generating a rendered document from the modified markup language document.

4. The method of claim 1, wherein identifying a plurality of resource requests in the markup language document comprises:
loading and interpreting a style sheet within the document; and
parsing the interpreted style sheet for embedded requests.

5. The method of claim 1, wherein the combined response includes an external cascading style sheet, and further comprising:
determining that the external cascading style sheet includes a second resource request;
generating a second combined request including the second resource request;
receiving a second combined response comprising a representation of the second resource; and
resolving the second resource request using the representation of the second resource in the second combined response.

6. The method of claim 1, wherein the requesting service obtains the respective resources from the plurality of resource locations and generates the combined response.

7. The method of claim 1, wherein generating a combined request comprising respective resource locations for the plurality of resource requests comprises:
determining that a particular resource is a cached resource;
including a token of the cached resource in the combined request;
determining that the combined response indicates that the cached resource is valid; and
resolving the resource request using the cached resource.

8. The method of claim 1, wherein generating a combined request comprising respective resource locations for the plurality of resource requests comprises:
determining that a particular resource is a cached resource;
including a token of the cached resource in the combined request;
determining that the combined response indicates that the cached resource is not valid; and
resolving the resource request using a representation of the particular resource in the combined response.

9. A computer-implemented method comprising:
receiving a combined request for resources, the combined request including resource requests for a plurality of embedded requests in a markup language document, wherein each resource request specifies a resource at a respective resource location;
obtaining each respective resource for the plurality of embedded requests;
generating a combined response comprising representations of one or more of the obtained resources; and
providing the combined response in response to receiving the combined request.

10. A system comprising:
one or more computers and one or more storage devices storing instructions that are operable, when executed by the one or more computers, to cause the one or more computers to perform operations comprising:
receiving a markup language document;
identifying a plurality of resource requests in the markup language document, wherein each resource request specifies a resource at a respective resource location;
generating a combined request comprising respective resource locations for the plurality of resource requests;
providing the combined request to a requesting service;
receiving, from the requesting service, a combined response comprising representations of one or more respective resources for the plurality of resource requests;
resolving the resource requests using the representations of the one or more resources of the combined response; and
generating a rendered document from the markup language document and the resolved resource requests of the markup language document.

11. The system of claim 10, further comprising a requesting service system comprising one or more computers configured to perform operations comprising:
receiving the combined request;
obtaining each respective resource for the plurality of resource requests;
generating a combined response comprising representations of one or more of the obtained resources; and
providing the combined response in response to receiving the combined request.

12. A computer program product, encoded on one or more non-transitory computer storage media, comprising instructions that when executed by one or more computers cause the one or more computers to perform operations comprising:
receiving a markup language document;
identifying a plurality of resource requests in the markup language document, wherein each resource request specifies a resource at a respective resource location;
generating a combined request comprising respective resource locations for the plurality of resource requests;
providing the combined request to a requesting service;
receiving, from the requesting service, a combined response comprising representations of one or more respective resources for the plurality of resource requests;
resolving the resource requests using the representations of the one or more resources of the combined response; and
generating a rendered document from the markup language document and the resolved resource requests of the markup language document.

13. The computer program product of claim 12, wherein resolving the resource requests using the representations of the one or more resources of the combined response comprises:
allocating a respective memory object for each of the representations of the resources in the combined response; and
loading the representations of the resources into the respecting allocated memory objects, wherein generating the rendered document from the markup language document and the resolved resource requests and the markup language document comprises generating the rendered document using in-memory pointers to the respective allocated memory objects.

14. The computer program product of claim 13, wherein the operations further comprise:
generating a modified markup language document including replacing references in the markup language to the resource locations with in-memory pointers to the respective allocated memory objects,
wherein generating the rendered document from the markup language document and the resolved resource requests and the markup language document comprises generating a rendered document from the modified markup language document.

15. The computer program product of claim 12, wherein identifying a plurality of resource requests in the markup language document comprises:
loading and interpreting a style sheet within the document; and
parsing the interpreted style sheet for embedded requests.

16. The computer program product of claim 12, wherein the combined response includes an external cascading style sheet, and further comprising:
determining that the external cascading style sheet includes a second resource request;
generating a second combined request including the second resource request;
receiving a second combined response comprising a representation of the second resource; and
resolving the second resource request using the representation of the second resource in the second combined response.

17. The computer program product of claim 12, wherein the requesting service obtains the respective resources from the plurality of resource locations and generates the combined response.

18. The computer program product of claim 12, wherein generating a combined request comprising respective resource locations for the plurality of resource requests comprises:
determining that a particular resource is a cached resource;
including a token of the cached resource in the combined request;
determining that the combined response indicates that the cached resource is valid; and
resolving the resource request using the cached resource.

19. The computer program product of claim 12, wherein generating a combined request comprising respective resource locations for the plurality of resource requests comprises:
determining that a particular resource is a cached resource;
including a token of the cached resource in the combined request;
determining that the combined response indicates that the cached resource is not valid; and
resolving the resource request using a representation of the particular resource in the combined response.
